(19) United States
(12) Patent Application Publication
(10) Pub. No.: US 2026/0309683 A1
(43) Pub. Date: Oct. 8, 2026

(54) QUICK-COOL COILED CHROMATOGRAPHIC COLUMN MODULE

(71) Applicant: MOCON, Inc., Minneapolis, MN (US)

(72) Inventors: Benjamin Lee Kahn, Blaine, MN (US); Emma Cecelia Olmanson, St. Paul, MN (US)

(21) Appl. No.: 19/567,174

(22) Filed: Mar. 15, 2026

Related U.S. Application Data
(60) Provisional application No. 63/783,565, filed on Apr. 4, 2025.

(51) Int. Cl. G01N 30/30

(52) U.S. Cl. CPC G01N 30/30

(57) ABSTRACT

A quick-cool coiled chromatographic column module and a gas chromatograph that incorporates one or more of the quick-cool coiled chromatographic column modules. The module includes a chassis, a cooling radial fan, a coiled chromatographic column, and a temperature sensor. The coiled chromatographic column is captured by the chassis so as to radially encircle the cooling radial fan at a radially spaced distance from the rotatable fan blades. Operation of the fan is controlled by the temperature of the coiled chromatographic column sensed by the temperature sensor.

### BACKGROUND

Rapid accurate gas chromatograph mud logging is a long-sought goal of the drilling industry. Current gas chromatographs capable of detecting and quantifying “light” organics (i.e., C₁₋₅) require several minutes per cycle, which is not well suited for use in mud logging as the drill head can move a significant distance before the results of each test are available and appropriate drilling adjustments can be made.

### SUMMARY OF THE INVENTION

We have discovered that a parameter primarily responsible for the extended cycle time between runs on a gas chromatograph used to detect and quantify light organics is the duration of the cooldown period between runs. Hence, we have developed a small module capable of quickly cooling a coiled chromatographic column whereby the duration of the cooldown period is greatly reduced and the cycle time for each run of the gas chromatograph is reduced.

A first aspect of the invention is a quick-cool coiled chromatographic column module that includes a chassis, a cooling radial fan, a coiled chromatographic column, and a temperature sensor. The cooling radial fan has rotatable fan blades that rotate about an axial axis secured to the chassis. The coiled chromatographic column is captured by the chassis so as to radially encircle the cooling radial fan at a radially spaced distance from the rotatable fan blades. The temperature sensor is configured and arranged to sense the temperature of the coiled chromatographic column and operable for transmitting a signal indicating the sensed temperature of the coiled chromatographic column to an on-off controller.

A second aspect of the invention is a gas chromatograph that incorporates one or more of the quick-cool coiled chromatographic column modules of the first aspect of the invention.

### BRIEF DESCRIPTION OF THE DRAWINGS

FIG. 1 is an exploded schematic view of one embodiment of the invention.

FIG. 2 is a rear perspective view of a fully assembled embodiment of the invention with a schematic depiction of the coiled chromatographic column.

FIG. 3 is a front view of the fully assembled embodiment of the invention depicted in FIG. 2.

FIG. 4 is an open-side side view of the fully assembled embodiment of the invention depicted in FIG. 2, with a schematic depiction of the coiled chromatographic column.

FIG. 5 is a schematic depiction of a gas chromatograph equipped with a pair of the quick-cool coiled chromatographic column modules depicted in FIG. 2.

### DETAILED DESCRIPTION OF A PREFERRED EMBODIMENT

### Definitions

As utilized herein, including the claims, the phrase “thermally insulating” means a k value of less than 3 W/mK, and the phrase “highly thermally insulating” means a k value of less than 1 W/mK, and the phrase “superior thermally insulating” means a k value of less than 0.5 W/mK.

Nomenclature Table

| REF. NO. | DESCRIPTION |
|---|---|
| 10 | Gas Chromatograph |
| 100 | Quick-Cool Coiled Chromatographic Column Module |
| 120 | Chassis |
| 120ₘ | Compartment Defining Unit of Chassis |
| 120ₙ | Faceplate Unit of Chassis |
| 121 | First Side of Assembled Chassis |
| 122 | Second Side of Assembled Chassis |
| 123 | Third Side of Assembled Chassis |
| 124 | Fourth Side of Assembled Chassis (Open Side) |
| 125 | First Face of Assembled Chassis |
| 126 | Second Face of Assembled Chassis |
| 127 | Standoff |
| 129 | Compartment Defined by the Chassis |
| 129ₘ | Air Flow Inlet Opening Through Compartment Defining |
| | Unit of Chassis |
| 129ₙ | Air Flow Inlet Opening Through Faceplate Unit of Chassis |
| 130 | Thermally Insulating Spools |
| 140 | Cooling radial fan |
| 142 | Fan Blades |
| 140ₐ | Axial Direction of Cooling radial fan |
| 140ᵣ | Radial Direction of Cooling radial fan |
| 157 | Electrical Leads for Powering the Cooling radial fan |
| 160 | Coiled Chromatographic Column |
| 180 | Temperature Sensor |
| 187 | Electrical Communication Lead Between Temperature |
| | Sensor and Controller |
| 190 | Heating Line |
| 197 | Electrical Leads for Powering the Heating Line |
| 200 | Controller |

### Construction

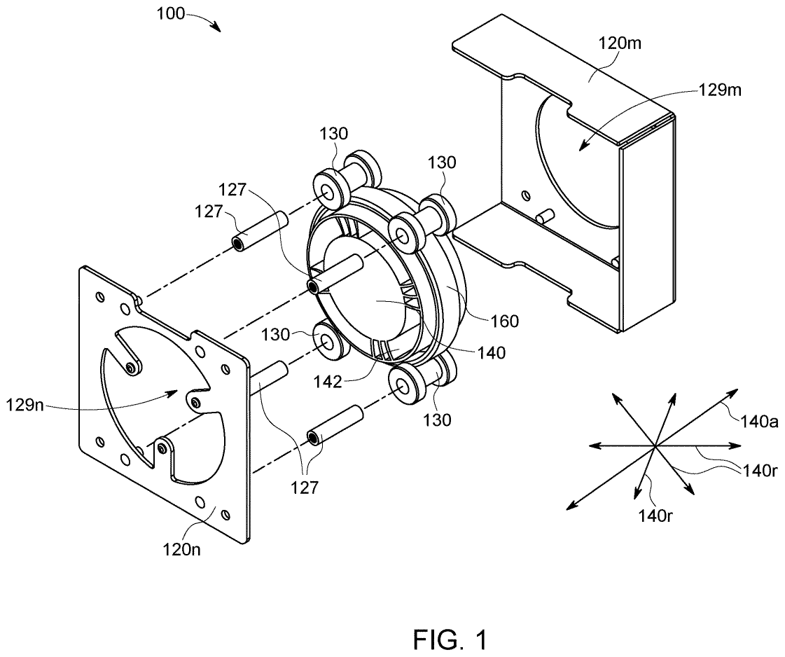

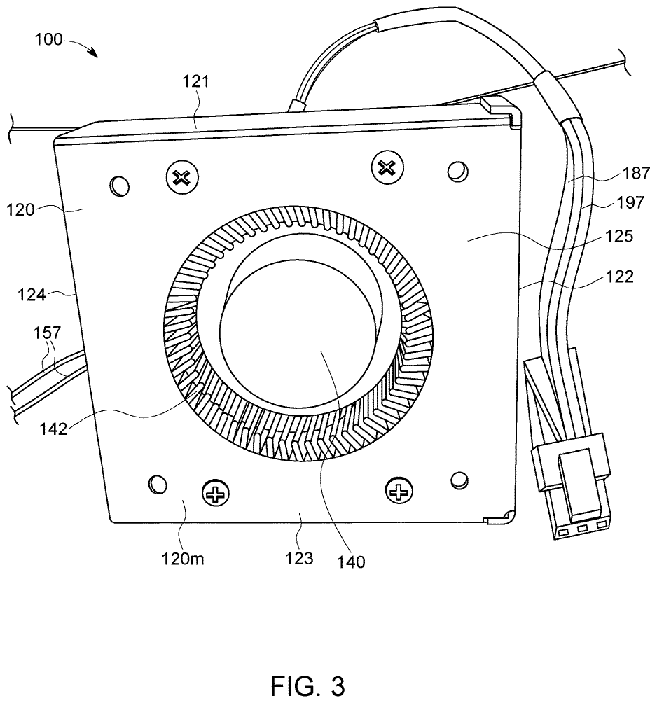

Referring generally to FIGS. 1-4, the invention is directed to a quick-cool coiled chromatographic column module 100, and a gas chromatograph 10 that incorporates one or more of the quick-cool coiled chromatographic modules 100. The quick-cool coiled chromatographic column module 100 includes a chassis 120, a cooling radial fan 140, a coiled chromatographic column 160, and a temperature sensor 180.

Referring generally to FIGS. 1-4, one embodiment of a suitable chassis 120 includes a compartment defining unit 120m, a faceplate unit 120n fastened to the compartment defining unit 120m defining a compartment 129, and a plurality of radially spaced standoffs 127 positioned between the compartment defining unit 120m and the faceplate unit 120n.

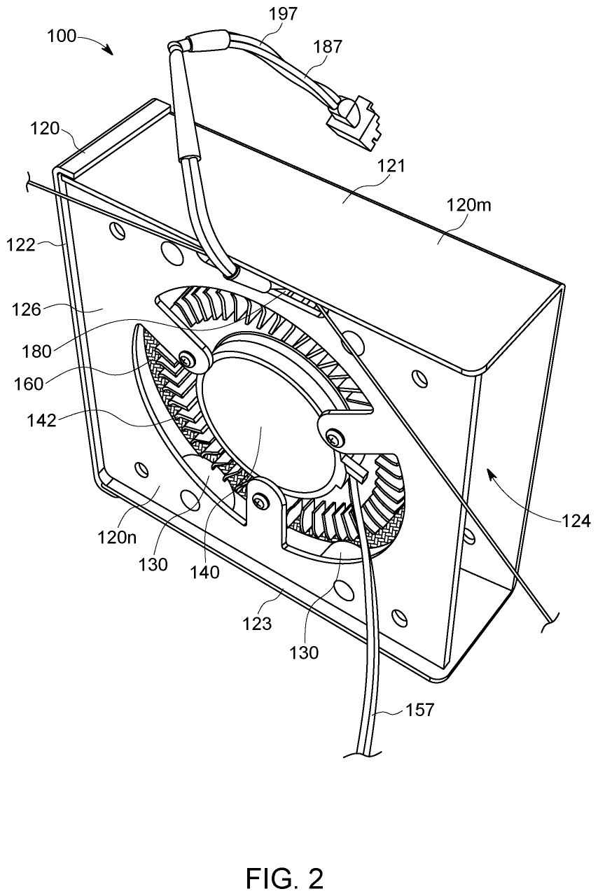

Referring generally to FIGS. 2-4, when assembled, the chassis 120 can include a first side 121, a second side 122, a third side 123, and a fourth side 124, a first face 125 and a second face 126, with one or more of the sides open or partially open. The assembled chassis 120 defines a compartment 129 having a longitudinal height between the first and third sides 121 and 123, a lateral width between the second and fourth sides 122 and 124, and a transverse thickness between first and second faces 125 and 126.

Referring generally to FIGS. 1-4, the cooling radial fan 140 is positioned within the compartment 129 and secured to the chassis 120, with the axial axis of rotation 140a of the cooling radial fan 140 extending in the transverse direction. An electrical lead 157 extends from the cooling radial fan 140 through the chassis 120 for powered connection to a source of electricity (not shown). Fan blades 142 on the cooling radial fan 140 rotate about the axial axis of rotation 140a so as to direct a cooling air flow radially outward 140r from proximate the axial axis of rotation 140a towards the sides 121, 122, 123 and 124 of the chassis 120.

Referring generally to FIGS. 1-3, the first and second faces 125 and 126 of the chassis 120 can each include an air flow inlet opening 129m and 129n respectively, for facilitating axial 140a air intake into the compartment 129.

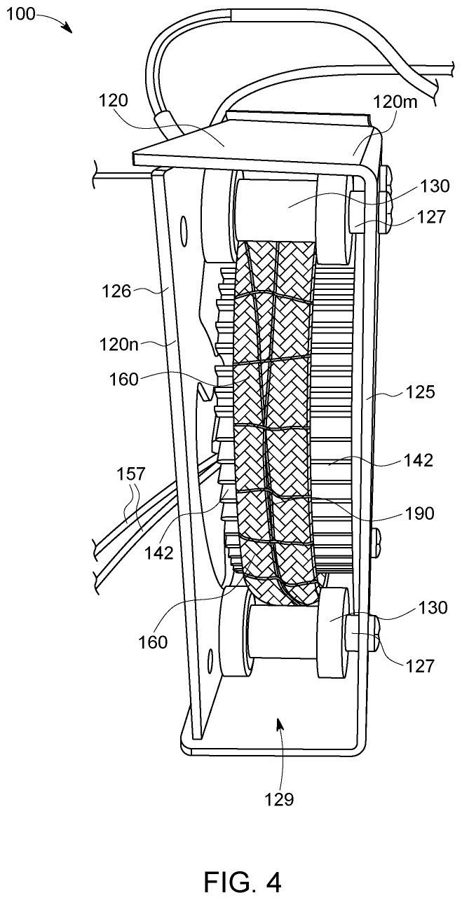

Referring generally to FIG. 4, the coiled chromatographic column 160 is captured by the chassis 120 so as to radially encircle the cooling radial fan 140 at a radially 140r spaced distance from the rotatable fan blades 142 whereby air flow generated by the cooling radial fan 140 can flow unabated into contact with substantially the entire 360° of the coiled chromatographic column 160.

The coiled chromatographic column 160 can be wound in substantially any fashion, with a preference for a uniform single helical layer or a basketweave single helical layer, both of which provide superior exposed surface area for contact by air flow emanating from the cooling radial fan 140.

A preferred radial spacing of the coiled chromatographic column 160 and the rotatable fan blades 142 is between 2 mm and 20 mm, and more preferably between 3 mm and 10 mm. A spacing of less than about 2 mm risks damaging contact between the coiled chromatographic column 160 and the rotatable fan blades 142 over time, while a spacing of greater than about 20 mm unnecessarily decreases the cooling effect of the air flow generated by the rotating fan blades 142.

Typical chromatographic columns 160, when coiled, will exert a radially 140r outward bias towards an uncoiled state and may thereby be conveniently captured by circumferentially spaced axially extending members (i.e., positioning the coiled chromatographic column 160 radially inside the standoffs 127 which serve as stops for preventing any further outward uncoiling of the coiled chromatographic column 160). In a preferred embodiment, the standoffs 127 themselves may be constructed of a thermally insulating material (i.e., a thermally insulating, highly thermal insulating or superior thermal insulating plastic) or a separate thermally insulating spools 130 made from a thermally insulating, highly thermal insulating or superior thermal insulating material such as plastic, may be mounted onto each standoff 127, for preventing thermal transfer and thermal damage to the standoffs 127 and other components of the module 100.

The coiled chromatographic column 160 can be substantially any type of chromatographic column including specifically but not exclusively a boiling point chromatographic column.

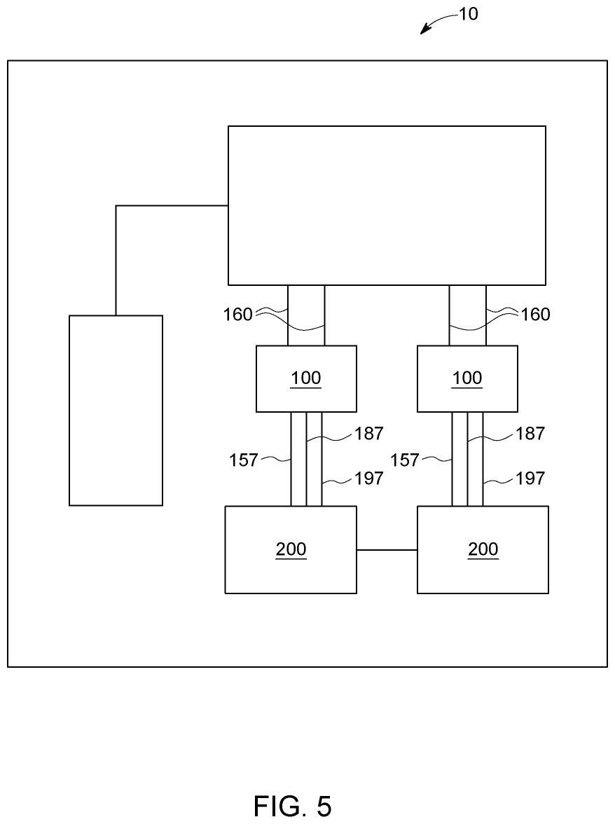

Referring generally to FIGS. 2 and 5, the temperature sensor 180 can be positioned within the compartment 129 for sensing the temperature of the coiled chromatographic column 160 and transmitting a signal along electrical communication lead 187 to a controller 200 onboard a gas chromatograph 10 indicating the sensed temperature of the coiled chromatographic column 160 for on-off control of the cooling radial fan 140. More specifically, the controller 200, based upon the sensed temperature signals received from the temperature sensor 180, preferably activates the cooling radial fan 140 when the sensed temperature exceeds a first threshold temperature and deactivates the cooling radial fan 140 when the sensed temperature drops below a second threshold temperature. The ΔT between the first threshold temperature and the second threshold temperature is preferably at least 50° C., and most preferably at least 100° C.

Referring generally to FIG. 4, a heating line 190 may be wrapped around the coiled chromatographic column 160 for heating a sample under test flowing through the coiled chromatographic column 160. An electrical lead 197 extends from the heating line 190 through the chassis 120 for powered connection to a source of electricity (not shown). The heating line 190 may also be in communication with the controller 200 via electrical communication lead 187 for on-off control.

We claim:

1. A quick-cool coiled chromatographic column module, comprising:
(a) a chassis,
(b) a cooling radial fan having rotatable fan blades that rotate about an axial axis secured to the chassis,
(c) a coiled chromatographic column captured by the chassis so as to radially encircle the cooling radial fan at a radially spaced distance from the rotatable fan blades, and
(d) a temperature sensor for sensing the temperature of the coiled chromatographic column and transmitting a signal indicating the sensed temperature of the coiled chromatographic column to an on-off controller.

2. The quick-cool coiled chromatographic column module of claim 1 further comprising: (e) a controller in communication with the temperature sensor for activating the cooling radial fan when the sensed temperature exceeds a first threshold temperature and deactivating the cooling radial fan when the sensed temperature drops below a second threshold temperature.

3. The quick-cool coiled chromatographic column module of claim 1 further comprising a heating line wrapped with the coiled chromatographic column for heating a sample flowing through the coiled chromatographic column.

4. The quick-cool coiled chromatographic column module of claim 1 wherein air flow generated by the cooling radial fan flows unabated into contact with the entire 360° of the coiled chromatographic column.

5. The quick-cool coiled chromatographic column module of claim 1 wherein the coiled chromatographic column is a coiled boiling point chromatographic column.

6. The quick-cool coiled chromatographic column module of claim 1 wherein the radially spaced distance between the coiled chromatographic column and the rotatable fan blades is between 2 mm and 20 mm.

7. The quick-cool coiled chromatographic column module of claim 6 wherein the radially spaced distance between the coiled chromatographic column and the rotatable fan blades is between 3 mm and 10 mm.

8. The quick-cool coiled chromatographic column module of claim 2 wherein the ΔT between the first threshold temperature and the second threshold temperature is at least 50° C.

9. The quick-cool coiled chromatographic column module of claim 2 wherein the ΔT between the first threshold temperature and the second threshold temperature is at least 100° C.

10. The quick-cool coiled chromatographic column module of claim 1 wherein the coiled chromatographic column is wound uniformly as a single helical layer.

11. The quick-cool coiled chromatographic column module of claim 10 wherein the coiled chromatographic column is a basketweave single helical layer.

12. The quick-cool coiled chromatographic column module of claim 1 wherein the captured coiled chromatographic column is captured by circumferentially spaced thermally insulating axially extending members.

13. The quick-cool coiled chromatographic column module of claim 12 wherein the circumferentially spaced thermally insulating axially extending members are plastic cylindrical spools.

14. The quick-cool coiled chromatographic column module of claim 1 wherein the captured coiled chromatographic column is captured by circumferentially spaced highly thermally insulating axially extending members.

15. The quick-cool coiled chromatographic column module of claim 14 wherein the circumferentially spaced thermally insulating axially extending members are plastic cylindrical spools.

16. The quick-cool coiled chromatographic column module of claim 1 wherein the captured coiled chromatographic column is captured by circumferentially spaced superior thermally insulating axially extending members.

17. The quick-cool coiled chromatographic column module of claim 1 wherein the circumferentially spaced thermally insulating axially extending members are plastic cylindrical spools.

18. A gas chromatograph including the quick-cool coiled chromatographic column module of claim 1.
